(19) United States
(12) Patent Application Publication
(10) Pub. No.: US 2004/0128522 A1
(43) Pub. Date: Jul. 1, 2004

(54) Software protection scheme for peripheral add-on cards

(76) Inventors: Chien-Hsing Liu, Shinjuang City (TW); Yung-Chih Chen, Taoyuan (TW); Xin-Cheng Shen, Taipei (TW)

Correspondence Address: Richard P. Berg, Esq., c/o LADAS & PARRY, Suite 2100, 5670 Wilshire Boulevard, Los Angeles, CA, 90036-5679, US

(21) Appl. No.: 10/429,126

(22) Filed: May 2, 2003

(30) Foreign Application Priority Data
Dec. 31, 2002 (TW) 91138097

(51) Int. Cl. H04L 9/00

(52) U.S. Cl. 713/189

(57) ABSTRACT

A software protection scheme for a peripheral add-on card mounted on a peripheral bus of a host system. According to the invention, a microcontroller reads a specific encrypted message from a non-volatile memory and decrypts it when a first reset signal of the peripheral bus is deasserted. After that, the microcontroller deasserts a second reset signal. When the second reset signal is deasserted, a microprocessor reads the specific decrypted message from the microcontroller. Then the microprocessor transmits the specific decrypted message via the peripheral bus to the host system for verification of the specific decrypted message. The host system will execute a protected program to start operations of the add-on card if the verification of the specific decrypted message succeeds.

### BACKGROUND OF THE INVENTION

1. Field of the Invention

The invention relates to software protection, and more particularly to a technique for protecting dedicated software of peripheral add-on cards from piracy and unauthorized use.

2. Description of the Related Art

For the purpose of optimizing peripheral add-on cards, control chips of such cards typically require that dedicated drivers or applications run properly under operating systems at host computers. It is also noted that recently the integrated circuit (IC) design has a tendency towards multi-function and System-On-a-Chip (SOC) design to fulfill various client requirements. Accordingly, the control chips of the peripheral add-on cards are generally provided with non-volatile memory interface to access customized codes and information in a non-volatile memory under control of the dedicated drivers or applications. As a result, peripheral add-on card vendors may differentiate their products for a variety of target markets by different programming and definition.

Nevertheless, traditional ways lack a secure mechanism to read/write non-volatile memories. Because there is no encryption mechanism, critical data and codes in a non- volatile memory are vulnerable to reverse engineering and illegal copy. If unauthorized access to such valuable information has occurred, intellectual property of the peripheral add-on card can be easily pirated and illegally distributed which results in significant loss of investments. Therefore, what is needed is a scheme to protect the intellectual property of the peripheral add-on card from unauthorized use and illegal copy.

### SUMMARY OF THE INVENTION

It is an object of the present invention to provide a software protection scheme of peripheral add-on cards to protect critical data and codes in a non-volatile memory against piracy and illegal copy.

It is another object of the present invention to provide a software protection method and arrangement to ensure intellectual property of peripheral add-on card against unauthorized use.

The present invention is generally directed to a software protection method for a peripheral add-on card that is mounted on a peripheral bus of a host system. In one aspect of the invention, a microcontroller reads a specific encrypted message from a non-volatile memory when a first reset signal of the peripheral bus is deasserted. At the microcontroller, the specific encrypted message is decrypted. After that, the microcontroller deasserts a second reset signal. When the second reset signal is deasserted, a microprocessor reads the specific decrypted message from the microcontroller and transmits it via the peripheral bus to the host system for verification of the specific decrypted message. If the verification of the specific decrypted message succeeds, the host system can execute a protected program to start operations of the add-on card. Periodically, an encrypted query message is sent through the peripheral bus by way of the microprocessor to the microcontroller, in which the encrypted query message is generated by the protected program. At the microcontroller, the encrypted query message is decrypted to generate a response message. Then the response message is transmitted by way of the microprocessor and the peripheral bus to the host system and is checked accordingly in the protected program. If the response message fails to meet the query message, the execution of the protected program is thus terminated.

In another aspect of the invention, a software protection arrangement made up of a host system and a peripheral add-on card is disclosed. The host system includes a peripheral bus whereon the peripheral add-on card is mounted. The peripheral add-on card comprises a non-volatile memory, a microcontroller and a microprocessor. The non-volatile memory is provided to store a specific encrypted message. The microcontroller is coupled to the non-volatile memory. When a first reset signal of the peripheral bus is deasserted, the microcontroller reads and decrypts the specific encrypted message from the non-volatile memory and then deasserts a second reset signal. The microprocessor is coupled between the peripheral bus and the microcontroller. When the second reset signal is deasserted, the microprocessor reads the specific decrypted message from the microcontroller and transmits it via the peripheral bus to the host system for verification. If the verification of the specific decrypted message succeeds, the host system can execute a protected program to start operations of the add-on card.

### DESCRIPTION OF THE DRAWINGS

The present invention will be described by way of exemplary embodiments, but not limitations, illustrated in the accompanying drawings in which like references denote similar elements, and in which:

FIG. 1 is a schematic block diagram illustrating a peripheral add-on card coupled to a host system via the PCI bus in accordance with a prior art;

FIG. 2 is a schematic block diagram illustrating a peripheral add-on card coupled to a host system via the PCI bus in accordance with the invention; and

FIGS. 3A through 3B are a flowchart of a preferred embodiment.

### DETAILED DESCRIPTION OF THE INVENTION

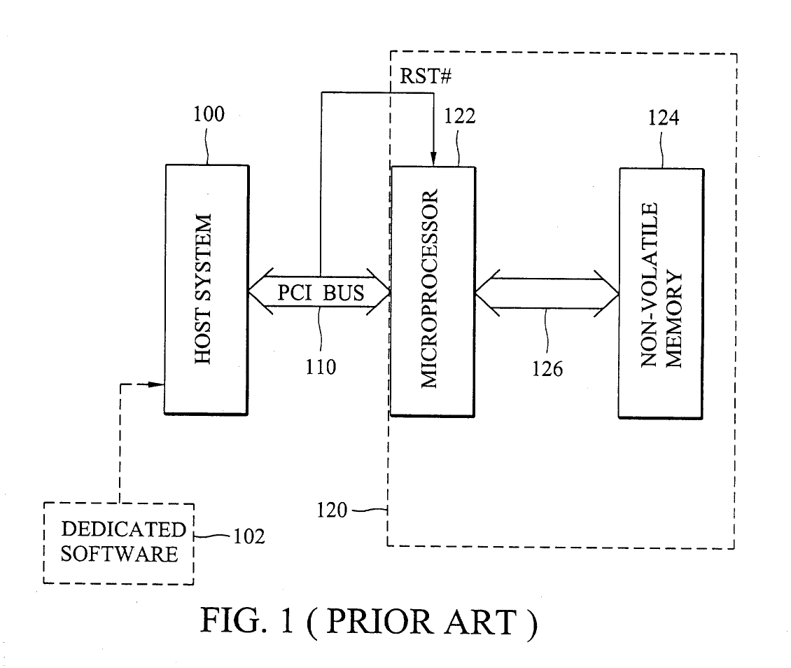

Referring to FIG. 1, a conventional peripheral add-on card 120 comprising a microprocessor 122 and a non-volatile memory 124 is illustrated. The microprocessor 122 includes a specialized interface 126 to transfer data with the non-volatile memory 124. It is known that the microprocessor 122 can be replaced by an Application Specific Integrated Circuit (ASIC). Still taking the microprocessor 122 as an example, a host system 100 has a Peripheral Component Interconnect (PCI) bus 110 to electrically couple to the peripheral add-on card 120. Through the PCI bus, the host system 100 is able to control as well as communicate with the microprocessor 122 of the peripheral add-on card 120. For the ASIC or microprocessor 122 of the add-on card 120, a dedicated driver or application 102 is loaded and executed by the host system 100 after power-on. Additionally, the microprocessor (or ASIC) 122 is reset to start operations of the peripheral add-on card 120 in response to a reset signal RST# of the PCI bus 110. In this traditional manner, the contents of the non-volatile memory 124 are vulnerable to interception and piracy due to the lack of a security mechanism.

The present invention mainly adopts a microcontroller incorporating a security mechanism to protect data in the non-volatile memory and dedicated software for the peripheral add-on card. In general, the difference between a microcontroller and a microprocessor is that the microprocessor is more complicated in circuitry as well as is computationally intensive and can provide more functions. To work properly, most of microprocessors are required to load firmware contained in an external memory and run the dedicated driver stored in a mass storage system. On the other hand, a simple microcontroller only needs to load firmware that is stored in its on-chip ROM (e.g., a non-volatile memory integrated directly in the microcontroller die). The on-chip ROM can be programmed during the manufacturing process and its contents cannot be easily read due to excellent protection. Hence, the microcontroller is well-suited to encryption and decryption tasks that are employed to ensure security.

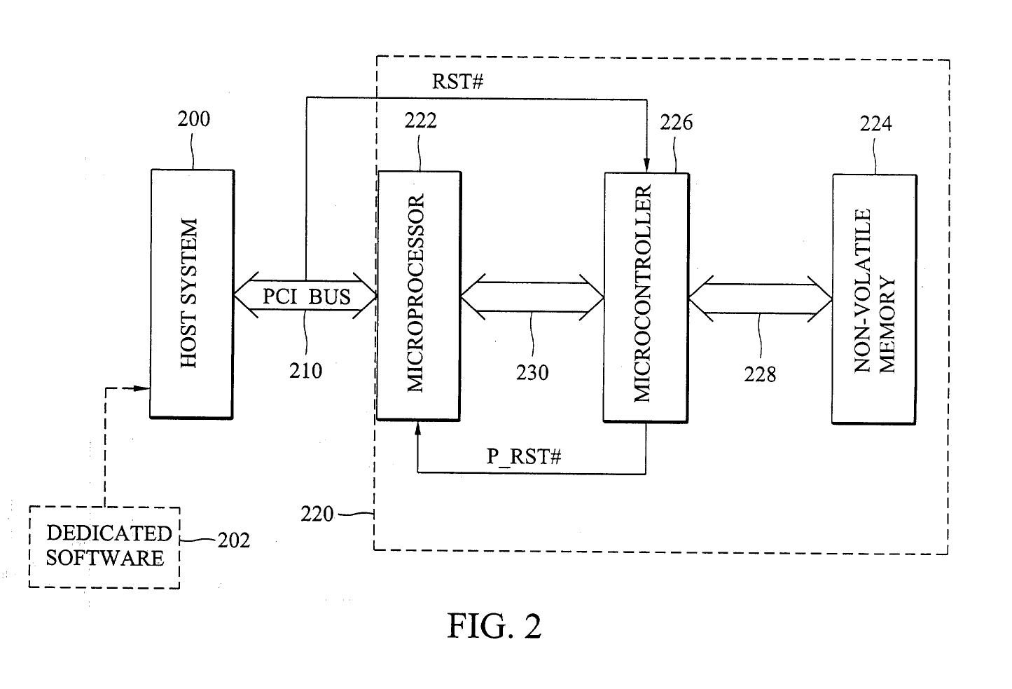

Referring to FIG. 2, a peripheral add-on card of the invention, identified by the number 220, includes a microprocessor 222, a non-volatile memory 224 and a microcontroller 226. The microcontroller 226 transfers data and program codes with the non-volatile memory 224 via an interface 228 and communicates with the microprocessor 222 via an interface 226. The interfaces 226 and 228 represent, but are not limited to, for example, a simple bi-directional two-wire interface based on the principles of operation of I²C which is an acronym for Inter Integrated Circuit bus for efficient inter-IC control. This leads to a more simplified circuit design. Furthermore, a host system 200 includes a peripheral bus 210 like the PCI bus whereon the peripheral add-on card 220 is mounted. After a dedicated driver or application 202 is loaded and executed, the host system 200 can control and communicate with the microprocessor 222 of the peripheral add-on card through the PCI bus 210.

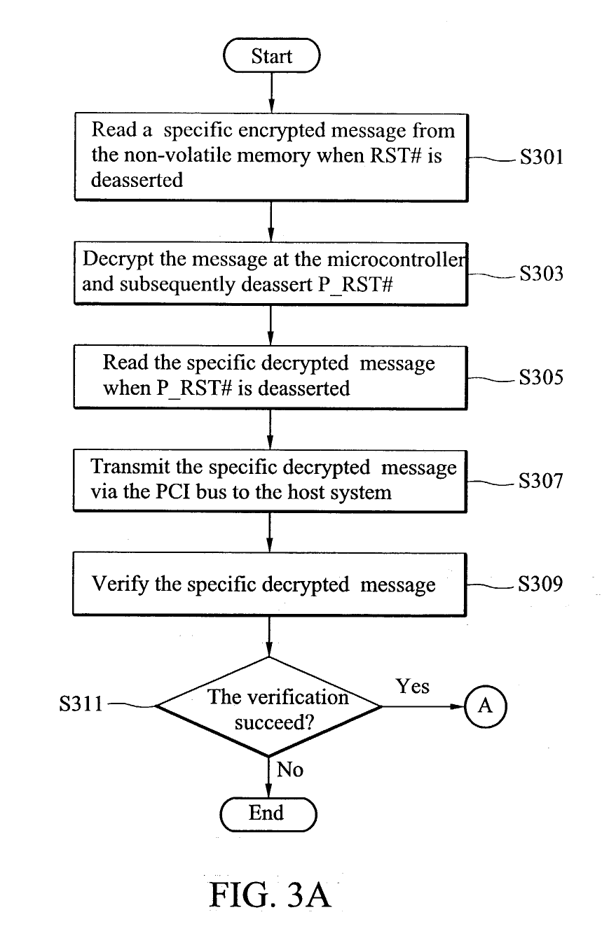

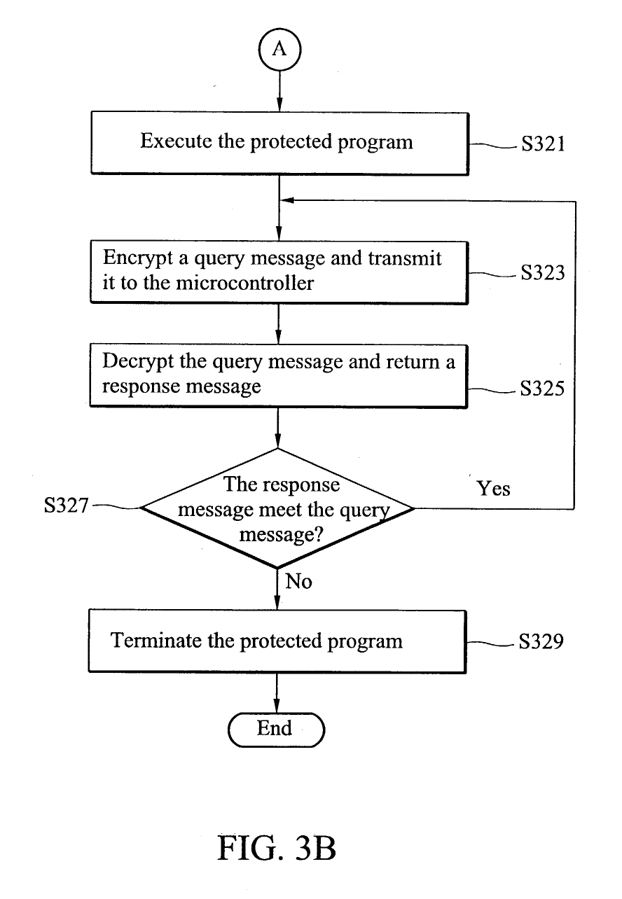

The features of the present invention will be more clearly explained from the embodiment of FIG. 2 taken in conjunction with the accompanying flowcharts of FIGS. 3A and 3B. The PCI specification requires the host system 200 to scan the PCI bus 210 to determine what devices are actually present. To do this, the configuration program must read the vendor ID and device ID in each possible PCI device after RST# is deasserted for a predetermined time of T_{rhfa}. The timing parameter T_{rhfa} is defined to be approximately 0.5 or 1 second for 33 MHz or 66 MHz PCI. Therefore, after RST# deassertion, the microcontroller 226 must acquire configuration data including the vendor ID and device ID from the non-volatile memory 224 within a time less than T_{rhfa}. When the reset signal RST# is deasserted, the microcontroller 226 reads a specific encrypted message from the non-volatile memory 224 via the interface 228 during system boot (step S301). In the preferred embodiment, the specific message comprises the vendor ID and device ID. At the microcontroller 226, the specific encrypted message is decrypted. After that, the microcontroller 226 deasserts reset signal P_RST# (step S303). When P_RST# is deasserted, the microprocessor 222 reads the specific decrypted message from the microcontroller 226 via the interface 230 (step S305). As the foregoing discussion, the microprocessor 222 needs to obtain the specific decrypted message within the predetermined time of T_{rhfa} to meet the requirement of the PCI specification.

The microprocessor 222 then transmits the specific decrypted message via the PCI bus 210 to the host system 200 for verification (step S307). At the host system 200, the specific decrypted message is checked (step S309) to see whether the message is decrypted properly to yield the correct vendor ID and device ID (step S311). If the verification fails, the running tasks related to the peripheral add-on card 220 are forced to terminate and operations of the add-on card 220 is stopped accordingly. It is the only way to decrypt the contents of the non-volatile memory 224 by the microcontroller 226. Thus, it is very difficult to use and tamper with the contents of the non-volatile memory 224 even if they are pirated.

If the verification of the specific decrypted message succeeds, the host system 200 executes a protected program 202 to start operations of the add-on card 220 (step S321). The protected program 202 herein comprises a dedicated driver or application for the microprocessor 222 of the add-on card 220. Thereafter, an encrypted query message is periodically sent through the PCI bus 210 and the microprocessor 222 to the microcontroller 226, in which the encrypted query message is generated from the protected program using a key K1 (step S323). The query message is preferably generated by a random process. At the microcontroller 226, the encrypted query message is decrypted using a key K2 to generate a response message. Then the response message is transmitted to the host system 200 by way of the microprocessor 222 and the PCI bus 210 (step S325). According to the invention, the encryption key K1 and the decryption key K2 can be prearranged to be different. Of course, keys K1 and K2 can be the same. The cryptographic algorithms such as RSA and Deffie-Hellman may be used to implement the encryption and decryption processes. The methods of encryption and decryption are is beyond the scope of the invention so they will not be described in detail herein.

At the host system 200, the response message is checked in the protected program 202 to determine whether it meets the query message (step S327). If so, the host system 200 continues executing the protected program 202. Hence the above steps are repeated periodically. If the response message fails to meet the query message, the execution of the protected program is terminated instantly (step S329). In this manner, it is very easy to determine whether the peripheral add-on card 220 is an unauthorized copy by checking the presence and functionality of microcontroller 226. Therefore, the present invention effectively protects the intellectual property of peripheral add-on cards against piracy and unauthorized use.

While the invention has been described by way of examples and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A software protection method for a peripheral add-on card mounted on a peripheral bus of a host system, comprising the steps of:
reading a specific encrypted message, by a microcontroller, from a non-volatile memory when a first reset signal of the peripheral bus is deasserted;
decrypting the specific encrypted message at the microcontroller;
subsequently deasserting a second reset signal by the microcontroller;
reading the decrypted specific message, by a microprocessor, from the microcontroller when the second reset signal is deasserted; and
transmitting the specific decrypted message, by the microprocessor, via the peripheral bus to the host system for verification of the specific decrypted message.

2. The software protection method of claim 1 further comprising the steps of:
executing a protected program at the host system to start operations of the add-on card if the verification of the specific decrypted message succeeds;
periodically sending an encrypted query message generated by the protected program through the peripheral bus and the microprocessor to the microcontroller;
decrypting the encrypted query message at the microcontroller to generate a response message;
transmitting the response message through the microprocessor and the peripheral bus to the host system;
checking the response message in the protected program; and
terminating the execution of the protected program if the response message fails to meet the query message.

3. The software protection method of claim 2 wherein the query message is encrypted by the protected program using a first key.

4. The software protection method of claim 3 wherein the encrypted query message is decrypted by the microcontroller using a second key to generate the response message.

5. The software protection method of claim 4 wherein the first key is the same as the second key.

6. The software protection method of claim 4 wherein the first and the second keys are prearranged to be different.

7. The software protection method of claim 1 wherein the specific decrypted message includes a vendor ID and a device ID which are compliant with the Peripheral Component Interconnect (PCI) specification.

8. The software protection method of claim 7 wherein the first reset signal is a PCI reset signal, and after the PCI reset signal is deasserted, the microprocessor is required to read the vendor ID and the device ID from the microcontroller within a predetermined time.

9. The software protection method of claim 8 wherein the predetermined time is defined as a timingparameter T_{rhfa} according to the PCI specification.

10. The software protection method of claim 2 wherein the query message is generated by a random process.

11. A software protection arrangement comprising:
a host system having a peripheral bus; and
a peripheral add-on card connected to the peripheral bus, comprising:
a non-volatile memory for storing a specific encrypted message;
a microcontroller, coupled to the non-volatile memory, for reading the specific encrypted message from the non-volatile memory when a first reset signal of the peripheral bus is deasserted, decrypting the specific encrypted message, and performing a deassertion of a second reset signal; and
a microprocessor, coupled between the peripheral bus and the microcontroller, for reading the specific decrypted message from the microcontroller when the second reset signal is deasserted and transmitting the specific decrypted message via the peripheral bus to the host system for verification of the specific decrypted message.

12. The software protection arrangement of claim 11 wherein the host system has a protected program, when the verification of the specific decrypted message succeeds, the host system begins to execute the protected program to start operations of the add-on card.

13. The software protection arrangement of claim 12 wherein the protected program includes a first key for encryption of a random query message and periodically transmits the encrypted query message through the peripheral bus and the microprocessor to the microcontroller.

14. The software protection arrangement of claim 13 wherein the microcontroller has a second key, and wherein the microcontroller decrypts the encrypted query message with the second key to yield a response message and transmits the response message by way of the microprocessor and the peripheral bus to the host system.

15. The software protection arrangement of claim 14 wherein the protected program executed by the host system checks the response message, if the response message fails to meet the query message, the host system terminates the execution of the protected program.

16. The software protection arrangement of claim 14 wherein the first key is the same as the second key.

17. The software protection arrangement of claim 14 wherein the first and the second keys are prearranged to be different.

18. The software protection arrangement of claim 11 wherein the peripheral bus of the host system conforms to the Peripheral Component Interconnect (PCI) specification.

19. The software protection arrangement of claim 18 wherein the specific decrypted message includes a vendor ID and a device ID which are compliant with the PCI specification.

20. The software protection arrangement of claim 19 wherein the first reset signal is a PCI reset signal, and the microprocessor is required to read the vendor ID and the device ID from the microcontroller within a predetermined time after the PCI reset signal is deasserted, and the predetermined time is defined as a timing parameter T_{rhfa} according to the PCI specification.
